(19) United States
(12) Patent Application Publication
(10) Pub. No.: US 2025/0220367 A1
(43) Pub. Date: Jul. 3, 2025

(54) EAR-WORN HEARING DEVICE WITH ELECTRICAL CABLE ASSEMBLY OR SOUND TUBE

(71) Applicant: KNOWLES ELECTRONICS, LLC, ITASCA, IL (US)

(72) Inventors: DONALD VERGHESE JACOB, CHICAGO, IL (US); STEPHEN ROYS, WEST CHICAGO, IL (US); CHRISTOPHER MONTI, ELGIN, IL (US); MATTHEW MANLEY, CRYSTAL LAKE, IL (US)

(21) Appl. No.: 18/960,376

(22) Filed: Nov. 26, 2024

Related U.S. Application Data
(63) Continuation-in-part of application No. 18/398,900, filed on Dec. 28, 2023.

(51) Int. Cl. H04R 25/00; H04R 1/10

(52) U.S. Cl. CPC H04R 25/60; H04R 1/1016; H04R 1/1033; H04R 25/65; H04R 2225/0216

(57) ABSTRACT

A hearing device component is disclosed. The component includes a housing containing the electrical or mechanical hearing device parts and an opening configured to receive an end portion of an electrical cable assembly, a sound tube or other member. One or more retention members protruding from an inner surface of the opening are configured to mechanically engage the electrical cable assembly, sound tube or other member disposed in the opening and resists movement thereof relative to the opening. The component can be implemented as a RIC unit, BTE unit of BTE electrical connector, among other hearing device components.

### CROSS-REFERENCE TO RELATED APPLICATIONS

The present application is a continuation in-part of co-pending U.S. patent application Ser. No. 18/398,900 titled, “Hearing Device Component With Electrical Cable Or Sound Tube” filed on 28 Dec. 2023, from which priority and benefits are claimed under 35 U.S.C. § 120.

### FIELD OF THE DISCLOSURE

The present disclosure relates generally to hearing devices and more particularly to hearing device components comprising an electrical cable assembly or sound tube, and combinations thereof.

### BACKGROUND

Some hearing devices comprise a housing connected to an electrical cable assembly or sound tube. One such hearing device is a receiver-in-canal (RIC) type behind-the-ear (BTE) hearing aid comprising a BTE unit worn against the backside of a user's ear and a RIC unit configured for at least partial insertion in the user's ear canal. An electrical cable assembly interconnects the BTE and RIC units. The BTE unit contains a microphone, an electrical circuit and batteries for converting sensed environmental sounds into an amplified electrical audio signal. The RIC unit comprises a balanced armature receiver (also referred to herein as a “receiver”) for converting the electrical audio signal to sound that is emitted into the user's ear canal. One end portion of the electrical cable assembly comprises a connector releasably connectable to the BTE unit. Another end portion of the cable assembly is permanently affixed to the RIC unit. A flange-shaped stopper (also called a “blunt”) over-molded, flame-formed, or glued onto the end portion of the electrical cable assembly prevents or at least resists rotation of the cable assembly and separation thereof from the RIC unit. In other hearing devices the speaker is located in the BTE unit and sound produced by the speaker propagates to the user's ear via a sound tube connected to the BTE unit, without the need for a RIC unit.

However, the process of adding the flange-shaped stopper is labor intensive and costly. The flanged-shaped stopper also increases the diameter and length of the cable assembly or sound tube. Moreover, this and other mechanisms for fastening the electrical cable assembly to the RIC unit, or sound tube to the BTE unit, have limited robustness and are subject to premature failure. Thus, there is an ongoing need for improvements in the art of connecting electrical cable assemblies and sound tubes to hearing device components.

### BRIEF DESCRIPTION OF THE DRAWINGS

The objects, features and advantages of the present disclosure will become more fully apparent upon consideration of the following detailed description and appended claims in conjunction with the accompanying drawings. The drawings depict only representative embodiments and are not considered to limit the scope of the disclosure.

FIG. 1 illustrates a hearing device comprising an in-ear unit and a base unit.

FIG. 2 is a partial sectional view of a representative in-ear unit.

FIG. 3 is an isometric view of a BTE unit electrical connector.

FIG. 4 is a sectional view of an interference fit between an electrical cable assembly or a sound tube and a receptacle portion of a hearing device housing.

FIG. 5 is an exploded sectional view of a hearing device housing and a portion of an electrical cable assembly or sound conduit.

FIG. 6 is a partial sectional view of the housing and cable assembly or sound conduit of FIG. 5 in an assembled state.

FIG. 7 is a partial sectional view of a portion of FIG. 6.

FIG. 8 is an isometric view of an electrical cable assembly or sound conduit receptacle portion of a hearing device component.

FIG. 9 is a partial sectional view of the receptacle portion of FIG. 8 retaining an electrical cable assembly or sound conduit.

FIG. 10 is an isometric view of an alternative electrical cable assembly or sound conduit receptacle portion of a hearing device component.

FIG. 11 is a partial sectional view of the receptacle portion of FIG. 10 retaining an electrical cable assembly or sound conduit.

FIG. 12 is an isometric view of an electrical cable assembly or sound conduit receptacle portion configured as a ferrule for assembly with a hearing device housing.

FIG. 13 is a partial sectional view of the ferrule of FIG. 12 assembled with a hearing device housing.

FIG. 14 is an end view of the ferrule of FIG. 12.

FIG. 15 is an isometric view of another electrical cable assembly or sound conduit receptacle portion configured as a ferrule for assembly with a hearing device housing.

FIG. 16 is a partial sectional view of the ferrule of FIG. 15 retaining an electrical cable assembly or sound conduit.

FIG. 17 is a sectional view of the ferrule of FIG. 15.

FIG. 18 is an isometric view of an electrical cable assembly or sound conduit receptacle portion configured as a ferrule for assembly with a hearing device housing member.

FIG. 19 is a partial isometric view of an electrical cable assembly or sound conduit receptacle portion comprising a retention member and a stop wall for an electrical cable assembly or a sound conduit.

FIG. 20 is an end view of the receptacle portion of FIG. 19.

FIG. 21 is an end view of a multipart hearing device housing retaining an electrical cable assembly or sound tube.

FIG. 22 is an exploded view of the multipart hearing device housing of FIG. 21.

FIG. 23 is an end view of a multipart hearing device housing having an opening symmetrically arranged in portions of the multipart housing.

FIG. 24 is an end view of the hearing device housing of FIG. 23 having an electrical cable assembly or sound tube disposed in the opening.

FIG. 25 is an end view of a multipart hearing device housing having an opening asymmetrically arranged in portions of the multipart housing.

FIG. 26 is an end view of the hearing device housing of FIG. 23 having an electrical cable assembly or sound tube disposed in the opening.

FIG. 27 is a partial sectional view along lines a-a of FIG. 26.

FIG. 28 is an end view of the multipart housing of FIG. 26 with the top housing portion removed.

Those of ordinary skill in the art will appreciate that the drawings are illustrated for simplicity and clarity and therefore may not be drawn to scale and may not include well-known features, that the order of occurrence of actions or steps may be different than the order described, that the order of occurrence of such actions or steps may be performed concurrently unless specified otherwise, and that the terms and expressions used herein have meaning understood by those of ordinary skill in the art except where a different meaning is specifically attributed to them herein.

### DETAILED DESCRIPTION

The disclosure relates generally to ear-worn hearing devices and components comprising an electrical cable assembly or sound tube, and more particularly to mechanisms for securely fastening the electrical cable assembly (also referred to herein as an “electrical cable” or “cable”), sound tube or other member to the hearing device or component, and combinations thereof. The component can be part of a receiver-in-canal (RIC) unit, a behind-the-ear (BTE) unit, or an electromechanical BTE connector, among other hearing device components. Representative examples are described further herein.

The hearing device or component generally comprises a housing containing electrical or mechanical hearing device parts. More specific examples of such parts are described further herein in the context of representative hearing device and components. The housing comprises an opening defining a passage configured to receive an end portion of an electrical cable assembly, sound tube or other member. The opening can be an integral part of a single or multipart housing. Alternatively, the opening can be in a discrete part, such as a ferrule, that is assembled with and retained by the housing or other component. One or more retention members protruding from an inner surface of the passage into the opening are configured to mechanically engage and retain the electrical cable assembly, sound tube or other member located in the opening. The one or more retention members resist movement (e.g., rotation or axial displacement) of the electrical cable assembly, sound tube other member relative to the inner surface of the opening when the electrical cable assembly, sound tube or other member is disposed in the opening.

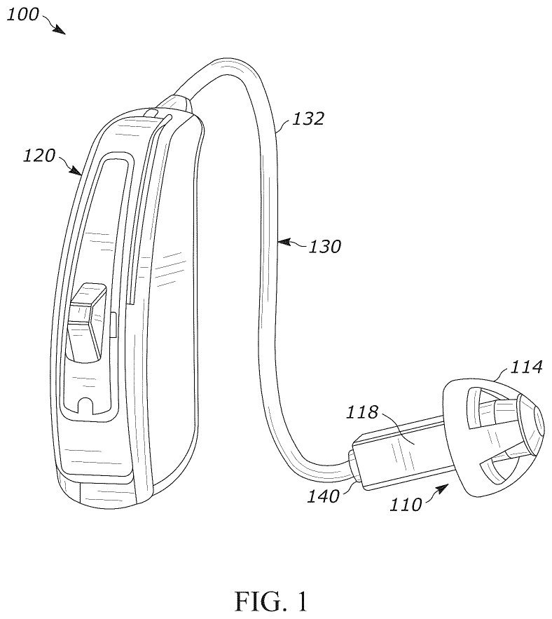

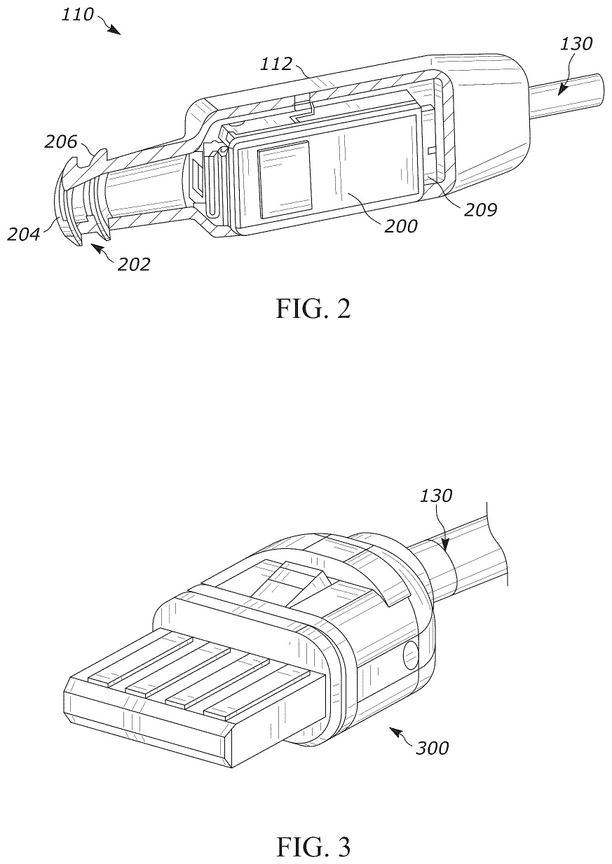

In one implementation, the hearing device component is a receiver-in-canal (RIC) unit comprising a speaker and an electrical cable assembly disposed in the opening of the housing. The electrical cable assembly is mechanically engaged with one or more retention members protruding from the opening of the housing to resist movement of the electrical cable assembly as described further herein. FIG. 1 illustrates an ear-worn hearing device 100 comprising a RIC unit 110 connected to a BTE unit 120 by an electrical cable assembly 130. A speaker of the RIC unit is acoustically coupled to a sound passage through a nozzle that supports a resilient ear-dome 114 configured for at least partial insertion in a user's ear canal. In FIG. 2, a representative RIC unit comprises a speaker 200 disposed in an external housing 112 integrated with a nozzle 202 having a sound passage 204 and exterior ribs 206 for retaining the ear dome (not shown in FIG. 2). In FIG. 1, the nozzle supporting the ear dome 114 is integrated directly with a speaker housing 118, without the external housing or other structure encapsulating the speaker housing shown in FIG. 2. In FIG. 1, the electrical cable assembly 130 is connected to a receptacle at an interface 140 of the speaker housing 118, examples of which are described further herein. Eliminating the external housing 112 shown in FIG. 2 can reduce the overall size of the RIC unit.

In FIGS. 1-2, the speaker is implemented as a balanced armature receiver (BAR) for its small size, electrical efficiency, and high audio fidelity. A receiver generally comprises one or more motor-actuated diaphragms for emitting sound in response to an electrical signal applied to the motor via the electrical cable assembly. In some implementations, multiple receivers can be acoustically coupled to the nozzle. Alternatively, the speaker can comprise a dynamic driver, a piezoelectric driver, a MEMS electrostatic driver, or any other suitable acoustic driver or a combination of two or more speakers.

The electrical cable assembly can be a preformed shape-retaining flexible member as shown in FIG. 1. Alternatively, the electrical cable assembly can be a non-shape retaining member, or a shape-retaining member deformable by the user for a customized fit. In FIG. 2, the electrical cable assembly comprises one or more electrical conductors disposed within an insulated conduit. The electrical wires can be multi-strand litz wires or other suitable electrical conductors. The electrical wires of the electrical cable assembly are connected to contacts 209 on an electrical interface of the speaker 200. The electrical cable may also comprise a strengthening member. The strengthening member may comprise fibers, such as Kevlar fibers, to stiffen the cable assembly.

In another implementation, the hearing device component is a BTE electrical connector comprising electrical contacts integrated with a BTE electrical connector housing. An electrical cable assembly disposed in an opening of the BTE electrical connector housing is mechanically engaged with one or more retention members protruding into the opening of the housing to prevent or resist movement of the electrical cable as described further herein. FIG. 3 illustrates a BTE electrical connector 300 connected to an electrical cable assembly 130. The BTE electrical connector is connected or connectable to a BTE unit configured to be worn behind the user's ear, as shown in FIG. 1. Some BTE electrical connectors are releasably connectable to the BTE unit by a mechanical and electrical connector to removably connect the RIC unit to the BTE unit. The BTE unit generally comprises one or more microphones, audio signal circuitry and batteries, among other circuits and sensors. The BTE unit provides electrical sound signals to the RIC unit via the electrical cable assembly.

In another implementation, the hearing device is a BTE unit comprising a speaker and a sound tube disposed in an opening of a housing of the BTE unit. The sound tube is mechanically engaged with one or more retention members protruding into the opening of the housing to resist movement of the sound tube as described further herein. The sound tube is shaped to extend from the BTE unit and into the user's ear canal, without a RIC unit. Thus configured, sound is propagated from one or more speakers in the BTE unit to the user's ear canal via the sound tube. The BTE unit connected to a sound tube is similar in overall structure to the hearing device 100 shown in FIG. 1 without the RIC unit 110, wherein the one or more speakers are in the housing of the BTE unit instead of a RIC unit.

Generally, one or more retention members protruding into the opening of the hearing device or component provide an interference fit with the electrical cable, sound tube or other member disposed in the opening. The interference necessary to secure the electrical cable, sound tube, or other member in the opening depends generally on the axial and rotational loads that will be applied to the interfering parts, the number of retention members, and materials characteristics of the interfering parts, among other considerations. The housing generally comprises a Young's modulus that is greater than a Young's modulus of the electrical cable assembly, sound tube or other member disposed in the housing. The housing can also generally comprise a yield strength greater than a yield strength of the electrical cable assembly or sound tube.

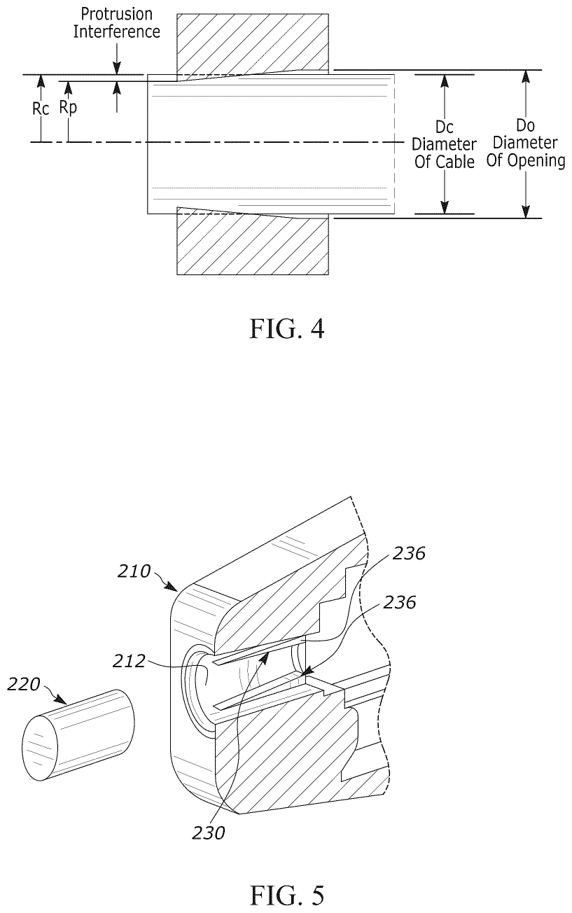

The interference can be characterized generally as a measure of overlap between interfering parts. In the representative embodiment of FIG. 4, a radial interference is characterized by a difference between a radius R_{c} of the electrical cable assembly, sound tube or other member and a radius Rₚ measured from an axis of the electrical cable, sound tube or other member to the point at which the retention member interferes most with the electrical cable, sound tube, or other member. In the representative hearing devices and components described herein, the radial interference can be approximately 0.02 millimeters or more between each of the one or more retention members and the electrical cable assembly, sound tube or other member.

The hearing device or component can also comprise clearance between portions of the inner surface of the opening and an outer diameter of the electrical cable assembly or sound tube. The clearance can accommodate deformation of the electrical cable or sound tube. The clearance can also accommodate glue or adhesive to further secure the electrical cable assembly, sound tube or other member in the opening. In the representative embodiment of FIG. 4, the clearance is characterized by a difference between a diameter Dₒ of the opening and a diameter D_{c} of the electrical cable assembly, sound tube or other member. In the representative hearing device components described herein, clearance between the outer diameter of the electrical cable assembly or the sound tube and the inner surface of the opening can be approximately 0.01 millimeters or more.

In FIGS. 5-7, a receptacle portion 210 for an electrical cable assembly or sound tube comprises an opening 212 into which an electrical cable, sound conduit or other member 220 can be inserted. The representative opening is integrated with a housing. In other implementations, the opening is part of a receptacle portion 210 configured as a ferrule that is assembled with the housing and secured thereto by retention features or glue or a combination thereof. Representative ferrules are described further herein.

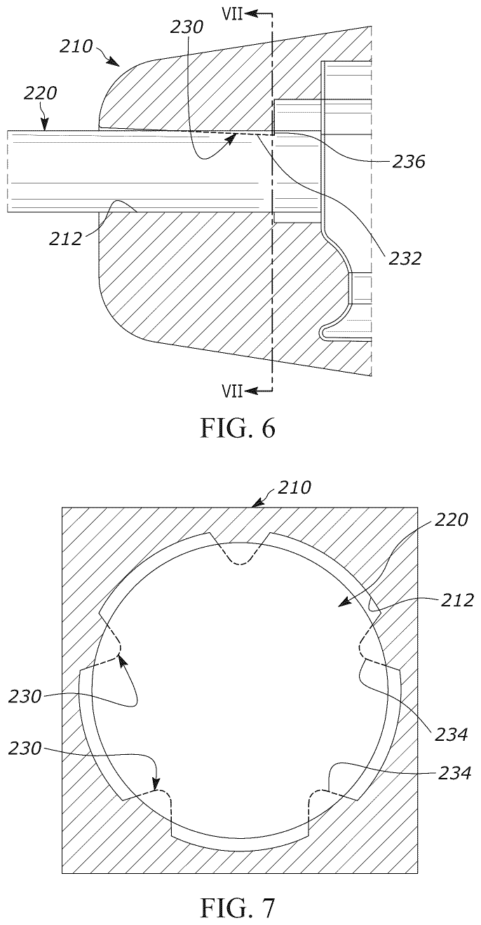

The opening comprises a plurality of retention members 230 protruding into the opening from a surface of the passage. The retention members comprise a tapered portion 232 having a ridge 234 (shown in FIG. 7). In FIGS. 5-6, the tapered portion comprises a barb defined in part by an edge at an end portion 236 of the tapered portion. Interference between the tapered retention member and the electrical cable, sound tube or other member increases during insertion thereof into the opening. Insertion of the electrical cable or sound tube beyond the barb enables the barb to bite into the electrical cable, sound tube or other member. In FIG. 7, the tapered retention members 230 are spaced equidistant from one another, but the spacing can also be irregular. In FIGS. 6-7, the retention members 230 are shown interfering with the electrical cable, sound tube or other member. The barbs and the ridges generally resist movement of the electrical cable or sound tube relative to the inner surface of the opening. The barbs and ridges can resist axial and rotational movement. However, the barb may more effectively resist axial movement than the ridge, and the ridge may more effectively resist rotational movement than the barb, depending on the precise configurations thereof.

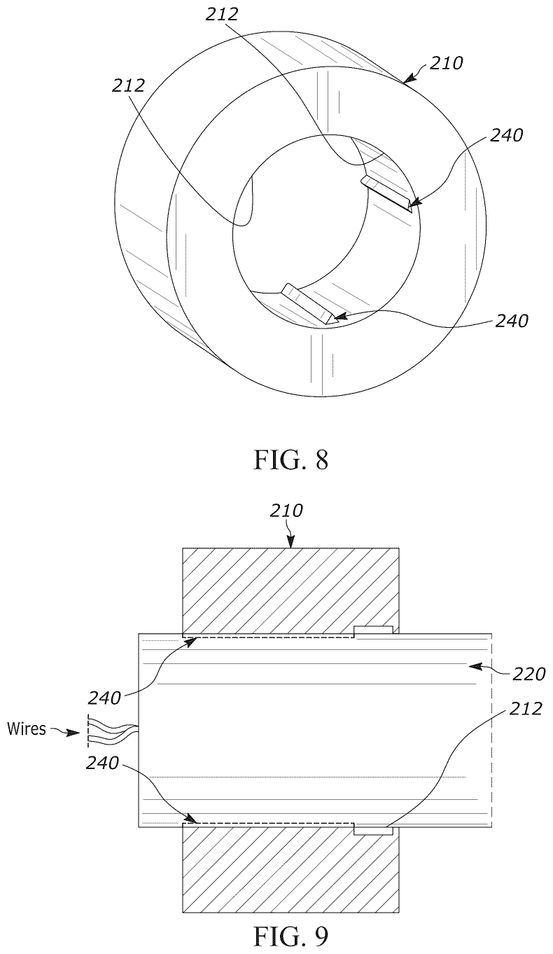

In FIGS. 8-9, a receptacle portion 210 of a hearing device component comprises a plurality of retention members configured as a plurality of longitudinal ribs 240 protruding from a surface of the passage and into the opening 212. The longitudinal ribs are aligned with an axis of the opening passage. The ribbed retention members 240 are spaced equidistant from one another, but the spacing can also be irregular. In FIG. 9, the ribs 240 are mechanically engaged with an electrical cable assembly, sound tube or other member 220 disposed in the opening 212 and the resulting interference fit prevents relative movement between the electrical cable assembly, sound tube or other member. The receptacle portion can be an integral part of a housing. Alternatively, the receptacle portion can be a discrete ferrule assembled with the housing.

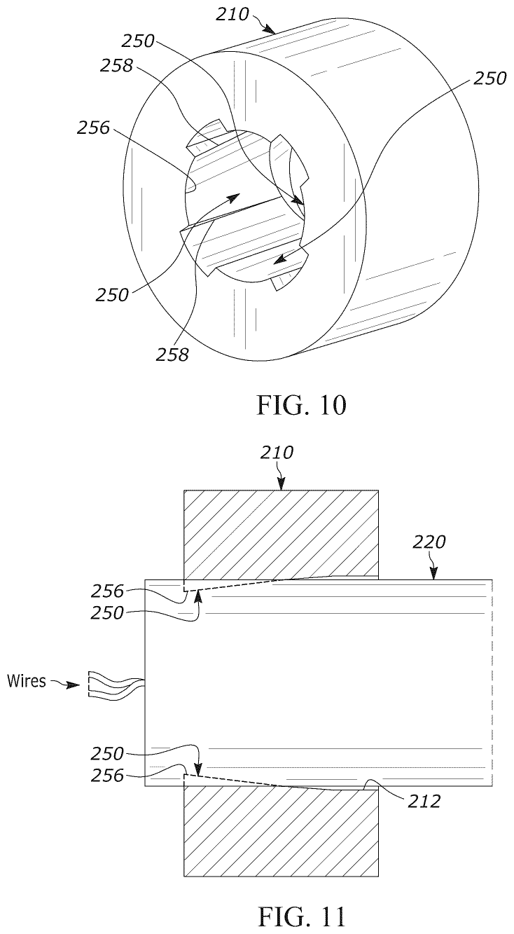

In FIGS. 10-11, a receptacle portion 210 of a hearing device component comprises a plurality of retention members configured as wedge-shaped members 250 protruding into an opening 212. Each retention member 250 comprises a portion reducing an effective diameter of the opening 212 along the axis of a passage defined by the opening. Each retention member also comprises a barb defined in part by an edge 256 at an end portion of the retention member. Edges 258 along axial portions of the retention member increase resistant to rotation. In FIG. 10, the retention members 250 are spaced equidistant from one another, but the spacing can also be irregular. Interference between the wedge-shaped members and the electrical cable, sound tube or other member increases during insertion thereof into the opening. Insertion of the electrical cable, sound tube, or other member beyond the barb enables the barb to bite into the electrical cable, sound tube or other member. In FIG. 11, the retention members are mechanically engaged with an electrical cable assembly 220 disposed in the opening 212 and the resulting interference fit prevents rotation and axial movement of the electrical cable assembly, sound tube or other member relative to the opening. The receptacle portion can be an integral part of a housing. Alternatively, the receptacle portion can be a ferrule assembled with the housing.

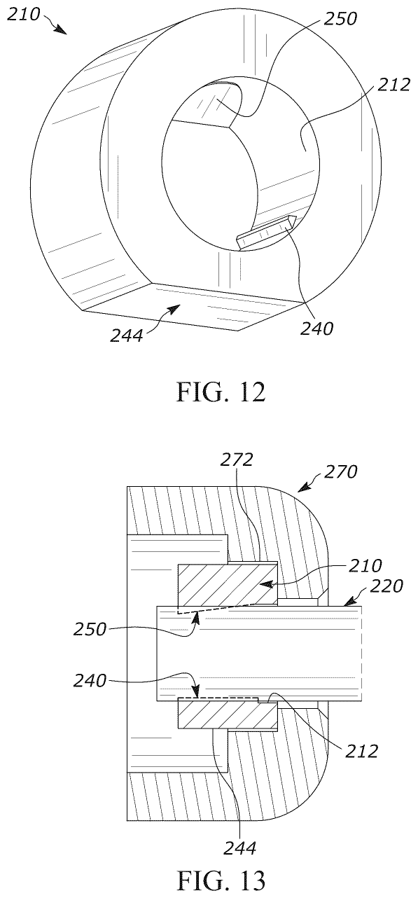

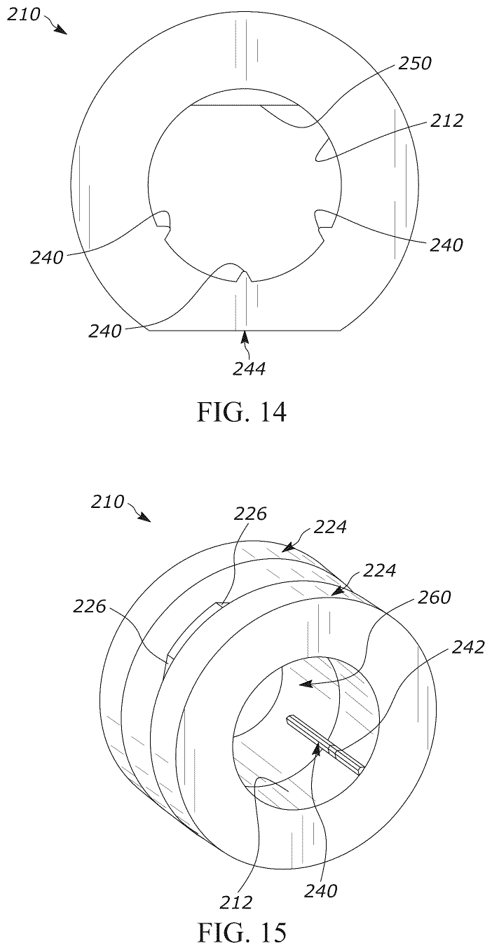

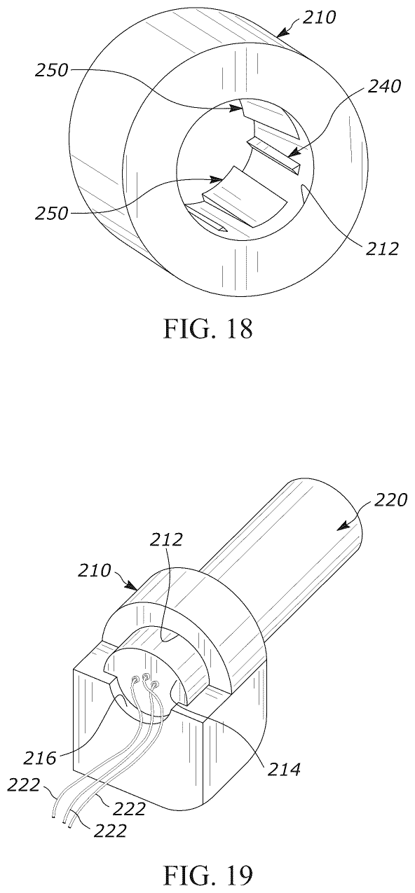

In FIGS. 12-14 and FIG. 18, a receptacle portion 210 of a hearing device component comprises retention members configured as one or more longitudinal ribs 240 and one or more wedge-shape members 250 protruding from a surface of a passage defined by an opening 212. In FIG. 14, the retention members are asymmetrically distributed about the opening 212, but the retention members can also be arranged symmetrically. In FIG. 18, the retention members 240 and 250 are alternately arranged and symmetrically distributed about the opening 212. The longitudinal ribs 240 function similarly to the longitudinal ribs of FIGS. 8-9, and the wedge-shaped members 250 function similarly to the wedge-shaped retention member of FIGS. 10-11.

In FIG. 13, the receptacle portion 210 is configured as a ferrule for assembly with a housing 270. The ferrule includes a retention feature configured to securely fasten the ferrule to a housing 270. The retention feature can be one or one or more flat surfaces 244 or other features that prevent rotational and axial movement of the ferrule relative to the housing. The housing can include an opening 272 having a complementary shape configured for receiving the ferrule with the anti-rotation feature. Alternatively, the opening can be an integral part of the housing without the discrete ferrule.

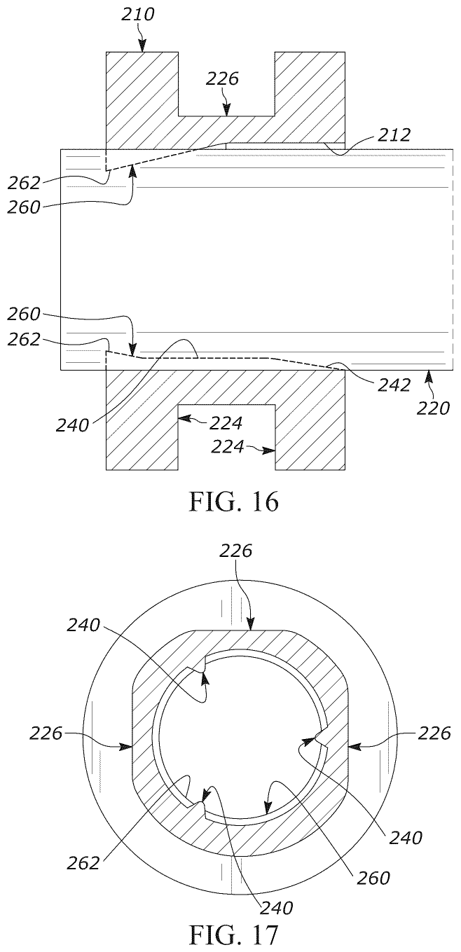

In FIGS. 15-17, a receptacle portion 210 is configured as a ferrule for assembly with a hearing device component. The retention members are configured as one or more longitudinal ribs 240 and a continuous annular wedge-shape member 260 protruding from a surface of the opening 212. The longitudinal ribs 240 have a tapered portion 242 along an axis of the opening and function similarly to the retention members of FIGS. 5-9. The annular wedge-shaped member comprises a barb defined in part by an edge 262. The annular wedge-shaped member functions similarly to the discrete wedge-shaped retention member of FIGS. 10-11. The ferrule can also comprise a retention feature configured to securely fasten the ferrule to the housing. In FIG. 15, the ferrule comprises one or more flat surfaces 226 on a recessed portion between outer flange portions 224. The ferrule can be configured to snap fit into an aperture of the housing or multiple housing portions can be assembled about the ferrule.

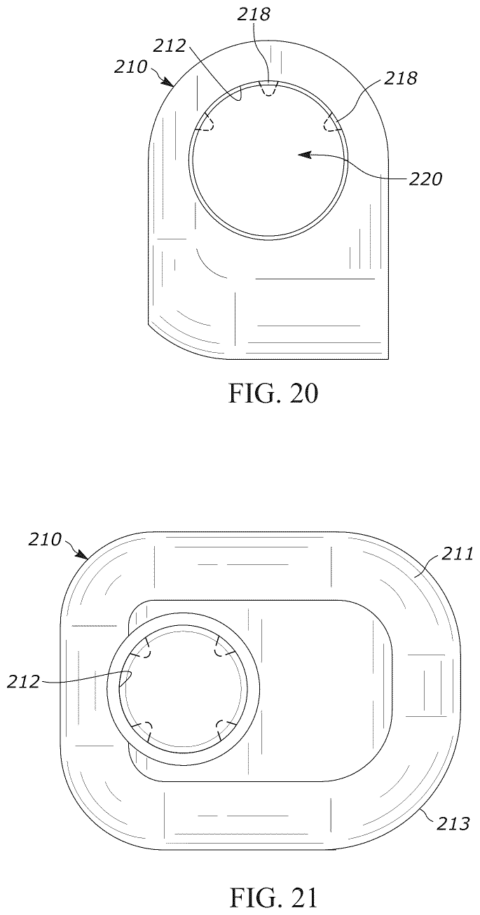

In FIGS. 19-20, a portion 210 of a hearing device component comprises an opening 212 having an end wall 214 with an aperture 216. In FIG. 20, the opening comprises one or more retention members 218 protruding from the surface of the opening and mechanically engaged with an electrical cable assembly, sound tube or other member 220 disposed in the opening to prevent movement thereof relative to the opening. The one or more retention members 218 can be implemented as any one or more of the representative retention members or combinations thereof described herein or illustrated in the drawings, among others. In FIG. 19, an end of the electrical cable assembly abuts against the end wall 214 of the opening when the electrical cable assembly is inserted into the opening. The end wall positively locates the electrical cable assembly in the opening and can ensure that the electrical cable assembly is inserted sufficiently into the opening for proper mechanical engagement with the retention members. Electrical wires 222 of the electrical cable assembly can extend through an aperture 216 of the end wall 214. More generally, the electrical cable assembly 220 can be a sound tube or other member disposed in the opening. The sound tube can be aligned with the aperture 216 of the end wall 214. In BTE units comprising a speaker, the aperture 216 can be acoustically coupled to the conduit of the sound tube, through which sound produced by a speaker located in the BTE unit propagates.

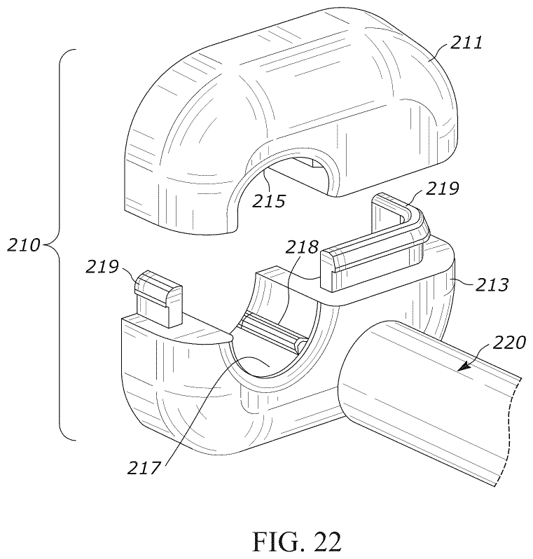

In FIGS. 21-22, a, hearing device component 210 comprises first and second housing portions 211 and 213 fastened together by complementary snap-fitting members. In FIG. 22, an opening is at least partially defined by a first opening portion 215 of the first housing portion 211 and a second opening portion 217 of the second housing portion 213 when the first and second housing portions are fastened together. One or more retention members protruding from a surface of the opening can be implemented as any one or more of the representative retention members or combinations thereof described herein or illustrated in the drawings, among others. The electrical cable assembly, sound tube or other member 220 can be captured between the first and second opening portions during assembly of the first and second housing portions. The representative snap-fitting members comprise protrusions 219 on the second housing portion 213 that fit into complementary recesses on the first housing portion 211. The protrusion can be retained therein by an interference fit, epoxy, weld or other means. In other implementations, other types of snap-fitting members can be employed.

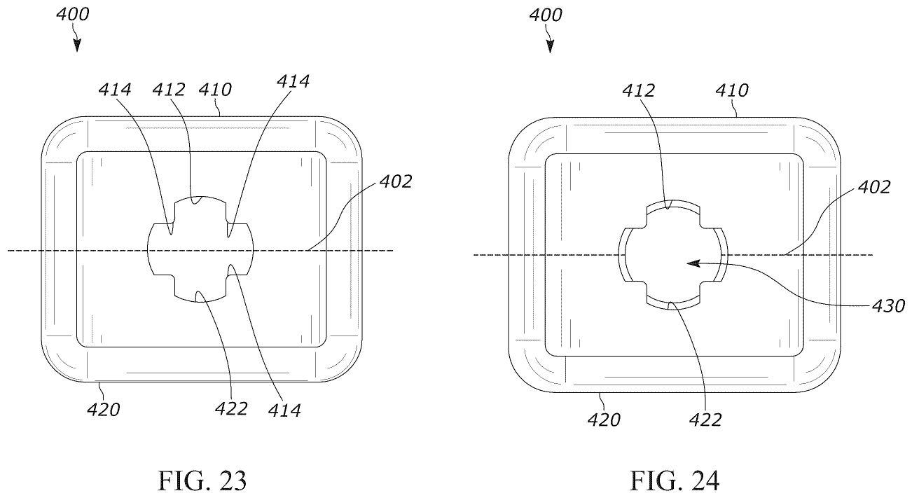

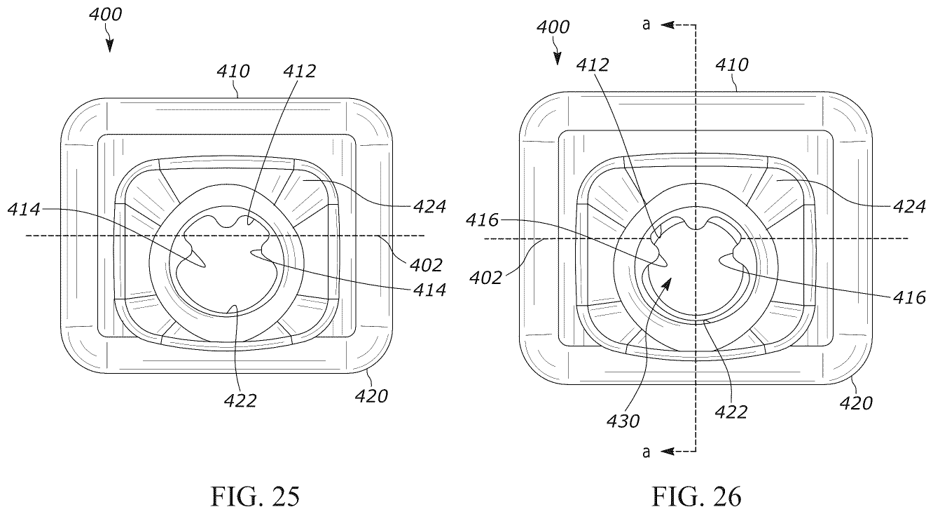

In another implementation, the housing of the hearing device component is an audio speaker housing connectable to an electrical cable assembly. The speaker housing can be a balanced armature receiver, dynamic or other speaker housing. FIGS. 23-26 show end views of a representative speaker housing 400 comprising a first housing portion 410 fastened to a second housing portion 420. The opening of the speaker housing is at least partially defined by a first opening portion 412 of the first housing portion and a second opening portion 422 of the second housing portion. The opening defines a passage through a wall portion of the housing when the first housing portion is assembled with the second housing portion. FIGS. 23 and 25 show the speaker housing without the electrical cable assembly. FIGS. 24, 26, 27 and 28 show an electrical cable assembly 430 disposed in the opening of the speaker housing or portion thereof. Alternatively, FIGS. 23-28 can be representative of a BTE unit connectable to a sound tube, or a connector housing connectable to an electrical cable assembly.

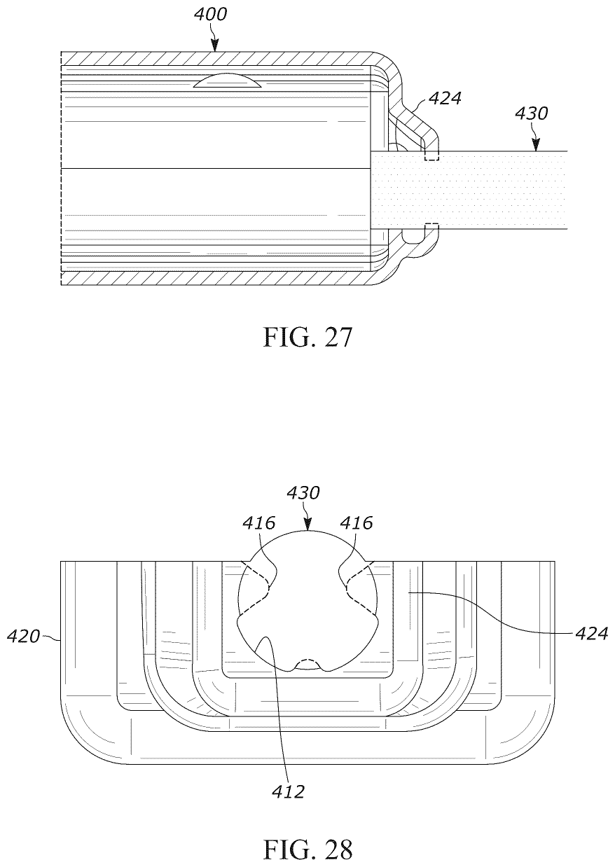

In FIGS. 25-28, the speaker housing comprises a bump-out 424 protruding from the end of the housing on which the opening 412 is located. The electrical cable assembly extends only partially into the speaker housing. The bump-out 424 provides space within the speaker housing to accommodate an end portion of the electrical cable assembly, or sound tube in other embodiments, without interference with other components contained within the housing, as shown best in FIG. 27.

The housing comprises multiple retention members each comprising a corresponding housing wall portion protruding into the opening. Thus configured, the retention members are an unassembled unitary part of the speaker housing. The retention members mechanically engage and retain the electrical cable assembly disposed in the opening to resist rotation and/or axial movement of the electrical cable assembly.

In one implementation, the housing comprises two metal housing portions formed by stamping and drawing sheet metal, among other metal forming operations. Balanced armature receiver housings typically comprise multiple metal housing portions commonly referred to as cups having relatively uniform wall thicknesses. BA cups typically have a thickness in a range of 4 to 8 thousandths of an inch more or less. In another implementation, the housing portions comprise plastic or some other material. The housing portions can be fastened together by welds or glue or other means suitable for the material of the housing.

In FIGS. 23-24, the first and second opening portions 412 and 422 of the speaker housing 400 have the same size and are located symmetrically about an interface 402 between mating surfaces of the first and second housing portions 410 and 420. The retention members of the first and second housing portions can be arranged symmetrically or otherwise relative to the interface 402 between the housing portions.

In FIGS. 25-26, the first opening portion 412 in the first housing portion is larger than the second opening portion 422 in the second housing portion. The second housing portion 420 comprises two retention members 416 extending into the second opening portion 422 proximate a mating surface of the second housing portion. In FIG. 28, two retention members 416 extending into the second opening portion 422 can retain the electrical cable assembly 430 disposed before the first housing portion is fastened to the second housing portion. The first housing portion can also comprise one more retention members, as shown in FIGS. 25-26.

While the disclosure and what is presently considered to be the best mode thereof has been described in a manner establishing possession and enabling those of ordinary skill in the art to make and use the same, it will be understood and appreciated that there are many equivalents to the representative embodiments described herein and that myriad modifications and variations may be made thereto without departing from the scope and spirit of the invention, which is to be limited not by the embodiments described, but by the appended claims and their equivalents.

What is claimed is:

1. An ear-worn hearing device comprising:
electrical or mechanical hearing device parts;
a housing containing the electrical or mechanical hearing device parts, the housing comprising:
an opening defining a passage configured to receive an end portion of an electrical cable assembly, sound tube or other member;
a retention member protruding from an inner surface of the passage, the retention member configured to mechanically engage the electrical cable assembly, sound tube or other member disposed in the opening,
wherein the retention member mechanically resists movement of the electrical cable assembly, sound tube or other member relative to the housing when the electrical cable assembly, sound tube or other member is disposed in the opening.

2. The ear-worn hearing device of claim 1 further comprising clearance between an outer diameter of the electrical cable assembly, sound tube or other member and the inner surface of the opening, wherein the retention member is configured to provide radial interference with the electrical cable assembly, sound tube or other member disposed in the opening.

3. The ear-worn hearing device of claim 2 further comprising a ferrule fastened to the housing, wherein the opening is disposed in the ferrule.

4. The ear-worn hearing device of claim 1, the housing comprising a Young's modulus greater than a Young's modulus of the electrical cable assembly, sound tube or other member.

5. The ear-worn hearing device of claim 1, the housing comprising a yield strength greater than a yield strength of the electrical cable assembly, sound tube or other member.

6. The ear-worn hearing device of claim 1, the retention member comprising a tapered portion having a ridge aligned with an axis of the passage, the tapered portion including a barb, wherein the barb resists movement of the electrical cable assembly, sound tube or other member relative to the opening.

7. The ear-worn hearing device of claim 1, the retention member comprising a rib aligned with an axis of the passage, wherein the rib resists rotation of the electrical cable assembly, sound tube or other member relative to the opening.

8. The ear-worn hearing device of claim 1, the retention member comprising a wedge-shaped portion aligned with an axis of the passage, the wedge-shaped portion comprising a portion reducing an effective diameter of the opening, the wedge-shaped portion comprising a barb mechanically engageable with the electrical cable assembly, sound tube or other member upon insertion thereof into the opening.

9. The ear-worn hearing device of claim 1, the opening of the housing comprising an end wall having an aperture, wherein an end of the electrical cable assembly or sound tube abuts against the end wall of the opening when the electrical cable assembly, sound tube or other member is inserted into the opening.

10. The ear-worn hearing device of claim 1, the housing is an assembly comprising first and second housing portions fastened together, the opening at least partially defined by a first opening portion of the first housing portion and a second opening portion of the second housing portion when the first and second housing portions are fastened together.

11. The ear-worn hearing device of claim 1, the housing is a balanced armature receiver housing connected to an electrical cable assembly, the housing comprising a first metal housing portion fastened to a second metal housing portion, the opening at least partially defined by a first opening portion of the first metal housing portion and a second opening portion of the second metal housing portion, the passage extending through a wall portion of the housing, multiple retention members each comprising a corresponding wall portion protruding into the opening, wherein each retention member is configured to mechanically engage and retain the electrical cable assembly in the opening.

12. The ear-worn hearing device of claim 11, the first opening portion larger than the second opening portion, the first metal housing portion comprising two retention members extending into the first opening portion proximate a mating surface of the first metal housing portion, wherein the two retention members of the first metal housing portion can retain the electrical cable assembly disposed in the first opening portion before the first metal housing portion is fastened to the second metal housing portion.

13. The ear-worn hearing device of claim 1 is a receiver-in-canal (RIC) unit comprising a speaker and an electrical cable assembly disposed in the opening of the housing and mechanically engaged with the retention member.

14. The ear-worn hearing device of claim 1 is a behind-the-ear (BTE) unit comprising a speaker and a sound tube disposed in the opening of the housing and mechanically engaged with the retention member.

15. The ear-worn hearing device of claim 1 is a behind-the-ear (BTE) connector comprising electrical contacts integrated with the housing and an electrical cable assembly disposed in the opening of the housing, the electrical cable assembly mechanically engaged with the retention member.

16. A hearing device comprising:
a balanced armature receiver comprising a housing having a nozzle configured for at least partial insertion in a user's ear canal, the housing comprising:
an opening defining a passage through a wall portion of the housing;
a retention member comprising a portion of the housing protruding into the opening;
an electrical cable assembly comprising a connector on one end portion and another end portion disposed in the opening of the housing, the retention member mechanically engaging and retaining the end portion disposed in the opening of the housing,
wherein the retention member resists movement of the electrical cable assembly relative to the housing.

17. The hearing device of claim 16, wherein the retention member resists rotation and axial movement of the electrical cable assembly relative to the housing.

18. The hearing device of claim 17, the housing comprising a first metal housing portion fastened to a second metal housing portion, the opening at least partially defined by a first opening portion of the first metal housing portion and a second opening portion of the second metal housing portion, multiple retention members each comprising a corresponding wall portion protruding into the opening.

19. The hearing device of claim 18, the first opening portion larger than the second opening portion, two of the retention members extending into the first opening portion proximate a mating surface of the first metal housing portion, wherein the two retention members of the first metal housing portion can retain the electrical cable assembly disposed in the first opening portion before the first metal housing portion is fastened to the second metal housing portion.

20. A hearing device comprising:
a receiver-in-canal component comprising a housing for a speaker and a nozzle configured for at least partial insertion in a user's ear canal, the housing comprising:
an opening defining a passage with an inner surface;
a retention member integrated with the housing and protruding from the inner surface of the opening;
an electrical cable assembly comprising an end portion disposed in the opening of the housing and mechanically engaged with the retention member,
wherein the retention member resists rotation and axial movement of the electrical cable assembly relative to the housing.

21. The hearing device of claim 20, the retention member comprising a tapered portion having a ridge aligned with an axis of the passage, the tapered portion including a barb, wherein the retention member resists rotation and axial movement of the electrical cable assembly.

22. The hearing device of claim 20, the opening of the housing comprising an end wall having an aperture, wherein an end of the electrical cable assembly abuts against the end wall of the opening when inserted into the opening and an electrical conductor of the electrical cable assembly extends through the aperture of the end wall.

23. The hearing device of claim 20, the housing is an assembly comprising first and second housing portions fastened together, the opening at least partially defined by a first opening portion of the first housing portion and a second opening portion of the second housing portion when the first housing portion is fastened to the second housing portion.

24. The hearing device of claim 23, the housing comprising a ferrule comprising a retention feature, the opening disposed in the ferrule, wherein the ferrule is fastened to the housing by the retention feature.
